(19) United States
(12) Patent Application Publication
(10) Pub. No.: US 2018/0335259 A1
(43) Pub. Date: Nov. 22, 2018

(54) Drying Kiln Configurations and Methods

(71) Applicant: S B KILN COATING & MAINTENANCE INC., Rathdrum, ID (US)

(72) Inventors: Marty Stutheit, Rathdrum, ID (US); Lonnie Stutheit, Post Falls, ID (US)

(21) Appl. No.: 15/598,110

(22) Filed: May 17, 2017

(51) Int. Cl. F26B 25/08; F26B 3/04; F26B 9/06

(52) U.S. Cl. CPC F26B 25/08; F26B 2210/16; F26B 9/06; F26B 3/04

(57) ABSTRACT

Lumber drying kilns are provided that can include a ceiling member supported by opposing wall members and a pair of complimentary baffles extending vertically from about a junction of the wall and ceiling. Drying kilns are also provided that can include a junction between a wall and a ceiling above material to be dried within the drying kiln and at least one baffle extending vertically along the side of the material to be dried. Methods for retrofitting existing drying kilns are provided that can include extending vertical baffles from about a junction of a wall and ceiling of the drying kiln. Methods for drying material within a drying kiln are also provided that can include placing material to be dried within a drying kiln and drying the material within the kiln while a pair of vertical extending baffles hang along opposing walls of the kiln.

### TECHNICAL FIELD

The present disclosure relates to material drying kiln configurations and methods. Particular embodiments provide wood or lumber drying kiln configurations and methods.

### BACKGROUND

Drying kilns are used to dry lumber, particularly, at as rapid a rate as practical while damaging as few pieces of lumber as possible. These drying kilns typically are formed as part of bays, and these bays have heating units and/or fan units inside these drying kilns. Users of drying kiln processes and methods are searching for ways to improve efficiencies and increase throughput. The present disclosure provides drying kiln configurations and methods that address some of the shortcomings of the current art of drying kilns and methods.

### SUMMARY OF THE DISCLOSURE

Lumber drying kilns are provided that can include a ceiling member supported by opposing wall members and a pair of complimentary baffles extending vertically from about a junction of the wall and ceiling.

Drying kilns are also provided that can include a junction between a wall and a ceiling above material to be dried within the drying kiln and at least one baffle extending vertically along the side of the material to be dried.

Methods for retrofitting existing drying kilns are provided that can include extending vertical baffles from about a junction of a wall and ceiling of the drying kiln.

Methods for drying material within a drying kiln are also provided that can include placing material to be dried within a drying kiln and drying the material within the kiln while a pair of vertical extending baffles hang along opposing walls of the kiln.

### DRAWINGS

Embodiments of the disclosure are described below with reference to the following accompanying drawings.

FIG. 1 is a drying kiln configuration according to an embodiment of the disclosure.

FIG. 2 is a drying kiln configuration with material to be dried within the kiln according to an embodiment of the disclosure.

FIG. 3 is a drying kiln in process of retrofitting according to an embodiment of the disclosure.

### DESCRIPTION

This disclosure is submitted in furtherance of the constitutional purposes of the U.S. Patent Laws “to promote the progress of science and useful arts” (Article 1, Section 8).

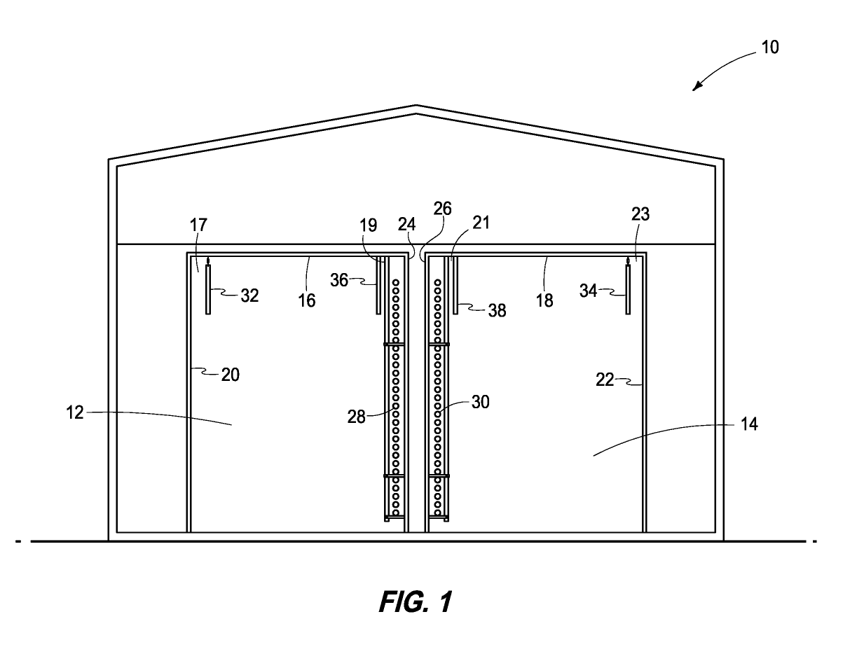

The present disclosure will be described with reference to FIG. 1-3. Referring first to FIG. 1, a drying house 10 is depicted as an example drying house. This drying house can include two bays; bay 12 and bay 14. Typically, the bays have ceilings 16 or 18 which may be coextensive, as well as walls 20 and 22 which join to form a junction with ceiling members 18 or 16 as configured. The ceilings and walls may have junctions 17 and 19, for example, as well as junctions 21 and 23. The bays may also have heating elements 28 and 30. Typically steam is utilized to heat the bays. The bays can be in tandem where the heating elements extend along just one shared wall, or the bays may be singular, or multiple bays may be utilized according to an embodiment of the disclosure. In accordance with example implementations, the bays can include a baffle or a pair of baffles 32 and 36, for example, or 38 and 34. These baffles can extend from about a junction 17, 19, 21 or 23 along each of the walls 20 or 28, 30 or 32, towards the floor, extending either from the ceiling or proximate the ceiling as desirable. These baffles can be constructed of a heat bearable material such as a rubber elastomer material, and these baffles can extend downwardly from the ceiling towards a floor of the kiln.

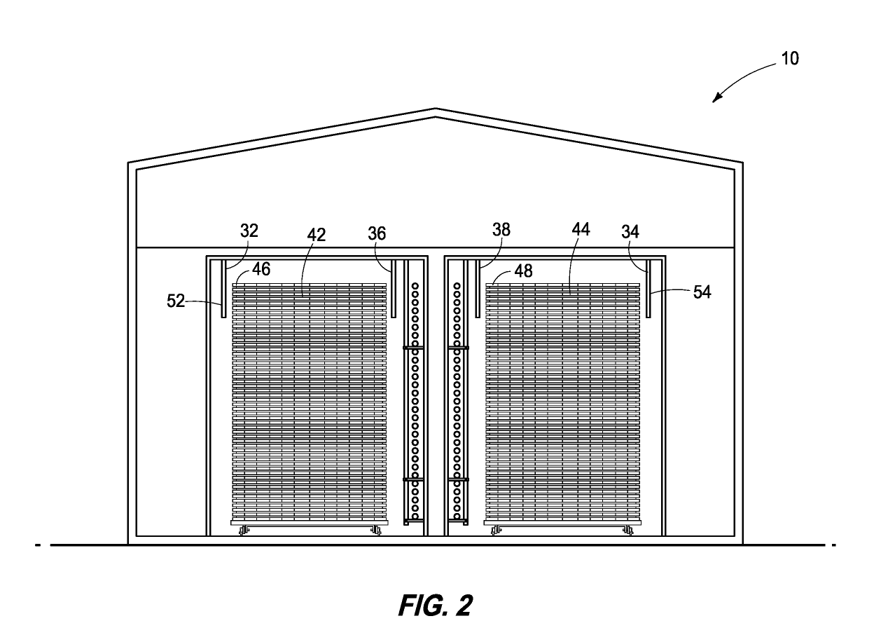

Referring next to FIG. 2, housing 10 may have material 42 to be dried therein. As shown, the material to be dried may be in pieces and be constructed of courses, with each course piece being separated from one another. The baffles 32 and 36 can extend from upward portion or junction towards along the side of the material to be dried; in some instances, at least two courses down or sometimes at least three courses down from above the top of the material to be dried. In accordance with example implementations, the material to be dried can be lumber, for example.

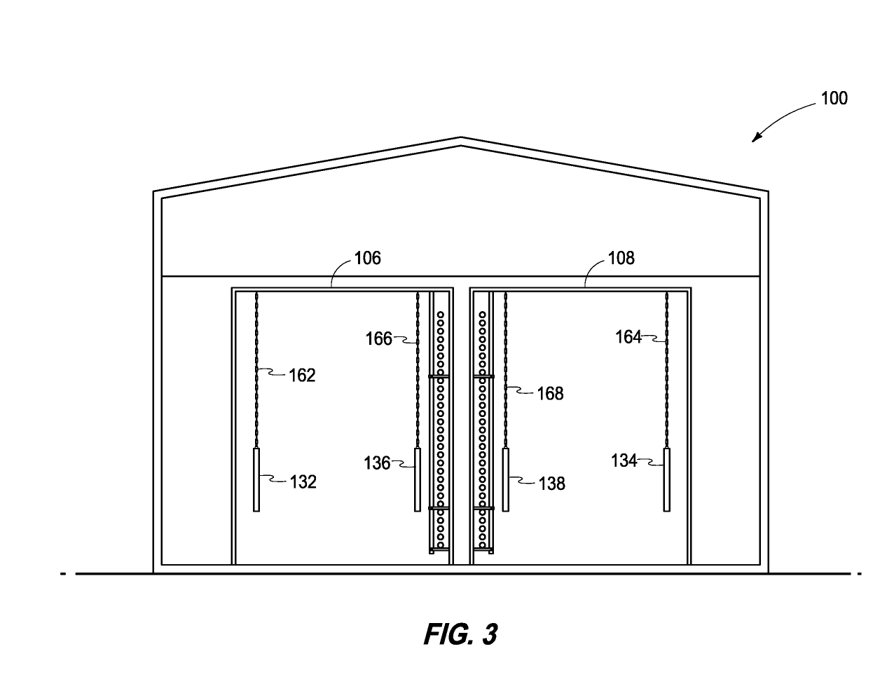

Referring next to FIG. 3, a retrofit is shown wherein existing kiln housing 100 has two bays, and the bays are retrofit with baffles according to embodiments of the present disclosure. In accordance with example implementations, the baffles can be extended or laid out along the floor opposing one another, and then strung into place along chains or cables or other heat resistant materials. These baffles 132 and 136 or 138 and 134 can be extended towards the ceiling to a point about a junction of the ceiling and the walls utilizing suspending mechanisms 162, 166, 168, and 164 to be associated with ceilings 106 and 108.

In compliance with the statute, embodiments of the invention have been described in language more or less specific as to structural and methodical features. It is to be understood, however, that the entire invention is not limited to the specific features and/or embodiments shown and/or described, since the disclosed embodiments comprise forms of putting the invention into effect.

1. A lumber drying kiln comprising:
a ceiling member supported by opposing wall members; and
a pair of complimentary baffles extending vertically from about a junction of the wall and ceiling.

2. The lumber drying kiln of claim 1 wherein at least one of the opposing walls supports a kiln heating source.

3. The lumber drying kiln of claim 1 wherein the baffles comprise rubber.

4. The lumber drying kiln of claim 3 wherein the rubber is high temperature rubber.

5. The lumber drying kiln of claim 4 wherein the high temperature rubber comprises silicone.

6. The lumber drying kiln of claim 1 wherein each of the baffles extends the length of the kiln.

7. The lumber drying kiln of claim 1 wherein the ceiling member and opposing walls define at least one bay of a multi-bay complex of drying kilns, wherein pairs of bays share a wall and that wall supports a kiln heating source.

8. A drying kiln comprising:
a junction between a wall and a ceiling above material to be dried within the drying kiln; and
at least one baffle extending vertically along a side of the material to be dried.

9. The drying kiln of claim 8 wherein the material to be dried comprises a top portion above a side of the material, the at least one baffle extending between the top portion and the wall of the drying kiln.

10. The drying kiln of claim 9 wherein the wall supports a heating assembly, wherein the baffle is positioned between the heating assembly and the material to be dried.

11. The drying kiln of claim 9 wherein the baffle is spaced apart from one or both of the wall and/or material to be dried.

12. The drying kiln of claim 8 wherein the material to be dried comprises courses of individual components of material, the individual components being spaced apart from one another, wherein the baffle extends from above the material to be dried to at least 2 courses below the top course of the material to be dried.

13. The drying kiln of claim 12 wherein the baffle extends from above the material to be dried to at least 3 courses below the top course of the material to be dried.

14. The drying kiln of claim 12 wherein the material to be dried is lumber and the individual components are pieces of lumber.

15. A method for retrofitting an existing drying kiln, the method comprising extending vertical baffles from about a junction of a wall and ceiling of the drying kiln.

16. The method of claim 15 wherein the baffles are positioned along opposite portions of a floor of the kiln, each of the baffles extending about the length of the kiln.

17. The drying kiln of claim 16 further comprising raising each of the baffles to about the junction from the ceiling.

18. A method for drying material within a drying kiln, the method comprising placing material to be dried within a drying kiln and drying the material within the kiln while a pair of vertically extending baffles hang along opposing walls of the kiln.

19. The method of claim 18 wherein at least one of the walls of the drying kiln supports a heating assembly.

20. The method of claim 18 wherein air flow is provided within the kiln at a flow of about 1200 F/M, and the kiln is maintained at a temperature of from about 80° F. to about 240° F.
